(19) United States
(12) Patent Application Publication
(10) Pub. No.: US 2024/0344723 A1
(43) Pub. Date: Oct. 17, 2024

(54) SOLAR POWERED ROOF VENTILATOR

(71) Applicant: ISWIRL PTY LTD, St lves, New South Wales (AU)

(72) Inventor: David SHEAR, St.lves, New South Wales (AU)

(21) Appl. No.: 18/701,053

(22) PCT Filed: Dec. 12, 2022
(86) PCT No.: PCT/AU2022/051492

§ 371 Date: Apr. 12, 2024

(30) Foreign Application Priority Data
Dec. 14, 2021 (AU) 2021904050

(51) Int. Cl. F24F 7/02; F24F 5/00

(52) U.S. Cl. CPC F24F 7/025; F24F 2005/0067

(57) ABSTRACT

A roof ventilator, for use with a throat mounted onto a roof, comprising a support assembly, for attaching to the throat, comprising: a body; a plurality of support arms for engagement with the inside surface of the throat, and a passageway running through the body. A solar panel support assembly, for supporting a solar panel, located at the top of the support assembly. A solar powered fan powered by a motor, located at the bottom of the support assembly. A blade support assembly rotatable relative to the body. A series of blades mounted to the blade support assembly and adapted to spin under the influence of air movement from the outside atmosphere. And, electronic circuitry from the solar panel through the passageway to the motor. The roof ventilator evacuates air either under the influence of movement of the series of blades and/or by operation of the solar powered fan.

This patent document claims priority from AU2021904050 the contents of which are hereby incorporated by reference in their entirety.

### TECHNICAL FIELD

The present invention relates to a roof ventilator that spin in the wind to remove warm air from the roof cavity.

### BACKGROUND

When a building heats up, it is desirable to remove as much of the warm air as possible to ensure the comfort of the people inside. Where items (such as stock) are kept in a building, it might be necessary to keep the building as cool as possible to conserve the items and stop them bring spoiled by the heat. Internal cooling systems (such as air conditioners) can be used to reduce the temperature inside the building. To complement internal cooling systems, warm air can also be evacuated from the roof space. The roof space is often a heat trap so the removal or warm or damp air therefore can improve the overall environment in a building.

One way of evacuating air from the roof space is a roof ventilator (or roof vent) that has blades that can spin in the wind. These are sometimes referred to as whirlybirds. The spinning of the blades of the roof vent can draw air out of the building and discharge it to the atmosphere. The effectiveness of a roof vent is determined by the airflow capacity. For a roof vent that has a diameter of about 30 cm in a wind speed of about 8 km per hour, the roof vent is thought to move about 10 cubic meters of air per minute from the roof cavity. If the speed of the blades increases, more air per minute will be moved until the vent reaches capacity. If the wind decreases, then less air will be moved. When the wind completely drops (to no wind), there may still be some movement of air due to the natural rising of hot air from the roof space, but without the pull from the wind, the amount of movement may be minimal.

The present invention seeks to provide a useful alternative to known roof ventilators.

### SUMMARY OF INVENTION

In a first aspect there is provided a roof ventilator for use with a throat mounted onto a roof so as, in use, to provide fluid communication between the interior of the roof space and the outside atmosphere, the roof ventilator comprising:
a support assembly for attaching the roof ventilator to the throat, the support assembly comprising:
   a body having a top and a bottom;
   a plurality of support arms extending from the body for engagement with the inside surface of the throat, and a passageway running through the body from the top to the bottom;
   is a solar panel support assembly, for supporting a solar panel, located at the top of the support assembly;
a solar powered fan powered by a motor, each of which are located at the bottom of the support assembly;
a blade support assembly provided on the body rotatable relative to the body;
a series of blades mounted to the blade support assembly, the series of blades adapted to spin under the influence of air movement from the outside atmosphere;
wherein, electronic circuitry from the solar panel travels from the solar panel through the passageway to the motor that powers the solar powered fan; and
wherein the roof ventilator is able to evacuate air either under the influence of movement of the first series of blades and/or by operation of the solar powered fan.

In embodiments, the roof ventilator is able to overcome the problem of reduced movement when there is little or no wind, because the solar powered fan can be operational. However, being able to integrate a solar powered fan and a series of blades is not straightforward. The internal mechanism of the roof ventilator has many moving parts and it is complex to create a design with is sustainable and cost effective during manufacture.

In U.S. Pat. No. 6,302,778 to Andrews, there is disclosed a roof ventilator in which there is a solar powered fan 53 and a series of turbine blades 30. This roof turbine highlights the problem solved by the present invention: namely, how to get the electronic circuitry from the photovoltaic cells to the fan to provide the fan with power in a most efficient way. In US'778, the solution is to provide the solar panels 70 on a shelf 69 which is supported by the motor 72. On windless days, it is said that solar panels 70 can be used to supply power to the motor 72 to turn shaft 14. Turning shaft 14 appears to cause all of the associated components including solar panels 70, motor 72 and shelf 69 to rotate. This inelegant solution has a number of drawbacks:
The location of the solar panels is fixed at horizontal, so there is limited ability to maximise solar gain with a tilt angle towards the sun.
Shaft 14 rotates under influence of the motor 72; however, there are thus efficiency losses from rotating the relatively heavy fan along with the shaft and the motor.
The longevity of a fan motor is decreased with incessant rotation.

In the present invention, it has been found that a passageway can be formed through the body of the support assembly. The passageway permits electronic circuitry to pass from the top of the support assembly to the bottom of the support assembly. This passageway eliminates the need for traditional a rotating shaft to turn the fan. By eliminating the need for a rotating shaft in the roof ventilator (such as that found in US'778 at item 14), the cables of the electronic circuitry can travel through the passageway without the need for electrical bushes or other transfer of power with related power-loss disadvantages.

Other prior art solutions provided such as CN209510670U and CN102287336A further highlight how difficult it is to integrate solar powered components into roof ventilators. In CN209510670U a structure is formed over the top of the roof ventilator to support a solar panel. In CN102287336A a structure is formed adjacent to the roof ventilator with power then

In the present roof ventilator, and to some extent with the prior art although nothing is admitted, when there is wind and sun, the series of blades and the solar powered fan can both be operating. This can increase the overall volume of air evacuated from the roof space. When the sun stops shining, but the wind remains, the solar powered fan may optionally stop operating, but the series of blades can move under the influence of the wind in the outside atmosphere and discharge air from inside the roof cavity to the outside atmosphere. When the wind drops, but the sun is shining, the series of blades may stop moving, but the solar powered fan can operate to discharge air from the roof cavity to the outside atmosphere. It is thought that when the solar powered fan rotates this may cause, even in wind free conditions, the series of blades to start moving. This may result in greater vacuum in the throat chamber resulting in enhanced air extraction. All of these advantages are desirable, but there has to also be a good structure that is simple and sustainable

The present roof ventilator can be referred to as a roof vent or a whirlybird. The roof onto which the roof ventilator can be mounted is not limited and can be a residential building or a commercial building. The building can be an enclosed structure, or it can be an open sided structure, although it should be understood that an enclosed structure is the more likely building on which the vent will be required, since air is more difficult to move out of an enclosed area. Nevertheless, in a building with open sides, hot air can still rise and become trapped in the roof space/cavity at the roof inner surface. The roof can be of any size including large in surface area or small in surface area. There can be one roof ventilator on the roof. There can be more than one roof ventilator on the roof. In some embodiments, there are a series of roof ventilators mounted on the roof. The size number and locations of the roof ventilators can be determined to optimise air movement from inside the building to outside the building.

The roof can have the throat pre-mounted on the roof surface in readiness for the present roof ventilator. The throat can be in position on the roof because an old (or previous) roof ventilator was removed. The throat comprises a channel which can be mounted over an opening in the roof. The throat channel includes a passageway defined by a wall at least part of which extends upwardly from the roof outer surface. The throat allows for fluid communication between the inner roof space and the outside atmosphere. By fluid communication it is meant that air can circulate between the roof space and the outside atmosphere in any direction including from inside the building (through the throat) to outside the building; or from outside the building (through the throat) to inside the building. The throat channel wall has an inside surface and an outside surface. In an embodiment, the cross-sectional area of the passageway of the throat is circular. A circular passageway provides a low friction air tunnel through which air can be evacuated. However, it should be understood that the throat could take any shape. The throats passageway can be about 30 cm in diameter. While 30 cm can be a typical diameter, it should be understood that the throat can have a wider or smaller diameter. The diameter can vary along the length of the passageway.

The roof ventilator comprises a support assembly for attaching the roof ventilator to the throat. The attachment of the support assembly to the throat can be by engagement with the inside surface of the throat. The engagement can be by tight interference fit of the support assembly into the throat. However, to prevent or at least substantially reduce any accidental dislodgement of the roof ventilator from the throat, the support assembly is attached to the inside surface of the throat by a fixing means. The fixing means can be by screwing, bolting, riveting or other. In an embodiment, the fixing means are a plurality of screws that pass through the support assembly and through the wall of the throat.

Since air needs to pass through the throat, preferably the support assembly is as streamlined as possible and allows passage of air therethrough. In an embodiment, the support assembly comprises a body having a top part and a bottom part. The top part of the body is located towards the top of the throat. The bottom part of the body is located towards the bottom of the throat closest to the roof space. The body can be shorter than the length of the throat such that it does not extend out of the top of the throat, nor does it extend through the bottom of the throat into the roof opening. Alternatively, the body can extend mostly out of the throat to elevate it upwardly and away from the throat and to allow the components of the roof ventilator space to function. The body can have a much smaller diameter than the throat to allow air flow around it. In an embodiment, the body is substantially cylindrical and is about one-third of the diameter of the throat or smaller. The body can form an annulus with the throat defined by the outside surface of the body and the inside surface of the throat. Air can flow around the outside surface of the body through the annulus.

A plurality of support arms can extend from the body of the support assembly. There can be any number of arms, but more than one is preferred for stability. The body will be in the throat, which is essentially a wind tunnel, so it is advantageous to affix it in position in a sturdy way. If the body is not rigidly attached into position in the throat, it will vibrate in the air flow through the throat as the air passes from the roof space, through the throat and out into the atmosphere. Accordingly, there are preferably at least two arms. Each arm is preferably as thin as possible when viewed in the wind direction (i.e. a birds eye view from the top of the throat down the passageway). More preferably, there are more than two arms to optimise stability. There can be 3, 4, 5, 6 or more arms. However, the addition of arms puts more obstacles into the air flow space inside the throat. Thus, in one advantageous embodiment there are three arms which may be optimum for secure and stable, vibration free attachment of the body to the throat and for optimising air passage through the throat tunnel.

Each arm can extend from about the centre of the body to the inside surface of the throat. However, this may cause the top part and or bottom parts of the body to have some flex and vibration in the air flow. Thus, to maximise the stability of the body, a first arm can extend from the top part of the body and a second arm can extend from the bottom part of the body. There can be further arms extending along the length of the body to increase stability. In one embodiment, rather than having a plurality of arms with spaces between them, a solid piece of material can be provided as each support arm. The solid piece of material can be an aerodynamic fin over which the air can flow and which increases the rigidity of the support assembly in the throat. The fin can be substantially triangular in shape having a wide part extending from the body and tapering to the location at which the arm joins the throat. The fin can be arranged so as to have its narrowest dimension (i.e. the thin cross sectional area) disposed in the direction of proposed air flow through the throat. In an embodiment, to reduce any torsional forces applied to the body by air flow over the fin, the radial fins are slightly offset from the body. Each support arm is affixed to the inside wall of the throat by the fixing means.

The body of the support assembly can be solid. The body of the support assembly can be hollow. If the body of the support assembly is hollow there can be a passageway running through the body from top to bottom. The passageway can allow air to travel through the body. The passageway can be formed by a hollow shaft. The shaft is fixed and does not rotate.

The body of the support assembly can comprise the blade support assembly. The blade support assembly is rotatable relative to the body. In an embodiment, the blade support assembly is rotatable around the shaft provided as a part of the body. The shaft can be the element described above with respect to the passageway, however, the shaft does not have to be hollow and could in embodiments be a solid rod. Nevertheless, in embodiments in which the shaft is hollow the blade support assembly can rotate around the shaft. In order to facilitate rotation, there can be a plurality of friction reducing bearings located close to the point of friction between the shaft and the blade support assembly. In an embodiment, the blade support assembly comprises two sets of friction reducing bearings spaced from one another. There can be a first series of friction reducing bearings spaced by about 5, 8, 10, 15 mm from a second series of friction reducing bearings. The provision of two or more sets of friction reducing bearings has been found to increase stability of the blade support assembly when rotating about the shaft. The blade support assembly can spin around the shaft when manual force is applied to it. However, the intended use is that the blade support assembly will support a series of blades. The blades or vanes are intended to be pushed under the influence of wind in the outside atmosphere. The stability of the blade support assembly is important because if the series of blades it supports start to wobble when spinning, the longevity of the roof ventilator is substantially reduced due to mechanical wear.

Each blade is a flat piece of material having a first face and a second face, longitudinal sides and an upper and lower end. The blades are preferably lightweight and solid pieces. The blades can be flat. The blades can be curved. The blades can be formed from a plurality of flat surfaces arranged to provide an overall curve like shape. Since the series of blades are moved by the wind, they should be oriented so that they can catch the wind and be moved by it. The series of blades can be disposed adjacent to one another, arranged vertically, in a ring shape. Each blade can be offset from the next blade to optimise air capture. The blades can be mounted at their upper and lower ends into a blade mount that fixes them into position. The blade mount can have an outside diameter greater than the diameter of the throat, so that the series of blades sit outside the throat. The blade mount can comprise a first and second wheel-shaped portion each having an inner mount face and an outer mount face. The inner mount face of each wheel-shaped portion can be coupled with the blade support assembly. The outer mount face of each wheel-shaped portion can be the location at which the upper ends (first wheel shaped portion) or lower ends (second wheel shaped position) of the blades are affixed. When fixed to the outer mount face of the blade mount, the blades cannot move. If a blade cannot move, when struck by the wind, the energy in the wind will cause a pushing force against the blade surface that will try to move the blade. Since the blade cannot itself move, the wind energy is transferred to the blade support assembly which rotates about the friction reducing bearings. When moving in the wind, the blades spin and whirl, hence the term whirlybird sometimes being attributed to such an arrangement.

At the top of the support assembly there is a solar panel support assembly for supporting a solar panel. The solar panel comprises a plurality of solar or photovoltaic (PV) cells, which can be used to generate electricity through photovoltaic effect. Each PV cell can convert solar radiation to electrical energy. The upper surface of the solar panel should be facing sunlight. In some embodiments, the mount of the solar panel is rotatable around the throat to change the orientation of the panel with movement of the sun. Once in position, the solar panel can be fixed in that position and does not move until further adjusted. The solar panel(s) do not rotate. The lowermost or underside surface of the solar panel can comprise electronic circuitry that will convert and then pass electricity formed by the cell (via wires) to another location for use. In an embodiment, the electricity formed could be saved into a battery.

The solar panel can be made from typical materials. A popular material is silicon. The solar panel can have any shape. In an embodiment, the solar panel is circular. The solar panel can have a diameter at least about 10 to 20% larger than the diameter of the throat. The solar panel can have a diameter of at least about 400 mm, 450 mm, 470 mm, 500 mm, 600 mm or 700 mm. The solar panel could be smaller or larger than described here. The solar panel can weigh about 5 to about 10 kg (or more or less) depending on its size, so the solar panel support assembly is preferably robust and stable once the panel is in position.

The solar panel is preferably held at or towards its peripheral edges to ensure complete support and any reduced tendency for the panel to twist or flex which is could cause damage to the PV cells. In an embodiment, the solar panel is held into a solar mount. The solar mount can comprise a frame that supports the edges of the panel, and an elevator which elevates the frame upwards relative to the support assembly so that the solar panel is arranged away from the series of blades and can be otherwise free from obstruction and disposed in sunlight. The solar mount can be inclined/inclinable so that the solar panel is positioned/positionable to capture optimum sunlight. The solar panel support assembly can comprise a platform on which the solar mount can be coupled. The coupling can be by bolting the lowermost part of the elevator to the platform. In an embodiment, the platform comprises an upper platform and a lower platform. There can be a solar mount foot at the lowermost part of the elevator. The solar mount foot can be configured to be received between the upper platform and the lower platform and then sandwiched into position. Before fixing the solar mount foot into position, the solar panel support assembly can be rotated into the required position for the solar panel to capture optimum sunlight. In an embodiment, the installation of the roof ventilator comprises first fixing the throat to the roof flashing, then attaching the support assembly to the throat. Once everything has been connected, the solar panel section can be rotated to optimum sunlight position. Preferably, the solar panel is open to sunlight without any obstruction such as a window or other similar obscuring opening between the photovoltaic cells and the sunlight rays that strike the photovoltaic cells.

At the bottom of the support assembly, there is a solar powered fan. The solar powered fan can have a rotating arrangement of blades disposed horizontally in the lower part of the throat. The fan can be about 10% less in diameter than the diameter of the throat, so as to allow the fan to rotate without the blades striking the inside surface of the throat. There can be any number of blades from 4, 5, 6, 7 or 8 blades. However, given the relatively small space and the throat typically being about 30 cm in diameter (so the fan is at most 27 cm in diameter) there can be about 4 blades in a preferred embodiment.

The solar powered fan is powered by a motor. Like the solar powered fan, the motor that powers the fan is also positioned at the bottom of the support assembly. This means that the power generated by the photovoltaic cells of the solar panel needs to reach the motor. The power can be transferred by electronic circuitry. The electronic circuitry can include one or more wires carrying the power necessary to drive the fan.

The solar powered fan is thus powered by the electricity generated by the solar panel. In order to receive electricity from the solar panel, the solar powered fan needs to be electrically connected to the solar panel. In previous arrangements, the electrical wires from the solar panel travel along the inside wall of the throat whereupon when reaching the solar powered fan, they can be connected to the motor driving the fan. However, a more elegant solution is, in an embodiment, for the wires to pass along the passageway formed in the body of the support assembly into the solar powered fan. By providing the support assembly with a hollow body having a passageway therein, there is an improved overall design that has less likelihood of failing due to damage to the wire(s) and the wires can be shortened which reduces material costs and increases overall performance. The fan can be disposed adjacent to the motor, which means that the motor can directly operate the fan rather than there needing to be any rotating shaft which remotely influences the fan. The motor can therefore be fixed and does not rotate in use. The wires from the solar panel can pass though an aperture in the solar panel support assembly, through the passageway and then into the motor driving the solar powered fan. In an embodiment in which the body includes a hollow shaft, the wires are advantageously disposed inside the hollow shaft passageway. The wires are not interrupted in any way by electrical bushes or similar so there are no related power-loss disadvantages. It is particularly advantageous that the solar panel is now integrated into the roof ventilator and does not have to be provided separately. This integration is more compact and aesthetically appealing and is more desirable to most customers.

The solar powered fan sits in the throat of the roof ventilator and is turned by the energy delivered to it by the solar panel. Accordingly, the solar powered fan is not reliant on wind energy to drive it and thus can operate in high winds or in low winds. In an embodiment in which a battery is provided, there can be a blade spinning sensor which detects when the series of blades is not spinning in the wind. When the blade spinning sensor communicates that the blades are not spinning, a message can be sent to the solar powered fan motor to activate and take over. In an embodiment, the motor driving the solar powered fan can receive energy from the solar panel directly and spins constantly notwithstanding whether the series of blades is turning or not.

In an embodiment, power generated by the roof ventilator can be captured and stored in a battery. The battery can be used to power either the series of blades, or the solar powered fan. The roof ventilator can be coupled with a thermostat so that operation thereof can be related to a temperature threshold. In an embodiment, the roof ventilator is monitorable and or controllable by an electronic device such as a smartphone.

### BRIEF DESCRIPTION OF THE FIGURES

Embodiments of the invention will now be described with reference to the accompanying drawings which are not drawn to scale and which are exemplary only and in which:

FIG. 1 is a perspective view of an embodiment of the roof ventilator in place on a roof.

FIG. 2 is schematic of a house with a roof showing how the roof ventilator could be positioned.

FIG. 3 is perspective view of a throat in which the roof ventilator can be mounted.

FIG. 4 is a perspective view of a support assembly according to an embodiment of the invention.

FIG. 5 is a cross-section along axis A-A′ of the roof ventilator of FIG. 6.

FIG. 6 is a cross section of an embodiment of a roof ventilator in position in a throat.

FIG. 7 is a close-up on the shaft and the blade support assembly and solar panel support assembly of the embodiment of FIG. 6.

FIG. 8 is an exploded view of the series of blades of the roof ventilator of FIG. 6.

FIG. 9 is a close-up of a blade from FIG. 8.

FIG. 10 is an exploded view of the roof ventilator of FIG. 6.

FIG. 11 is an exploded view of the solar panel and solar mount of FIG. 6.

FIG. 12 is a cross-section of the solar mount showing the frame and elevator and solar mount foot.

### DETAILED DESCRIPTION OF EMBODIMENTS OF THE INVENTION

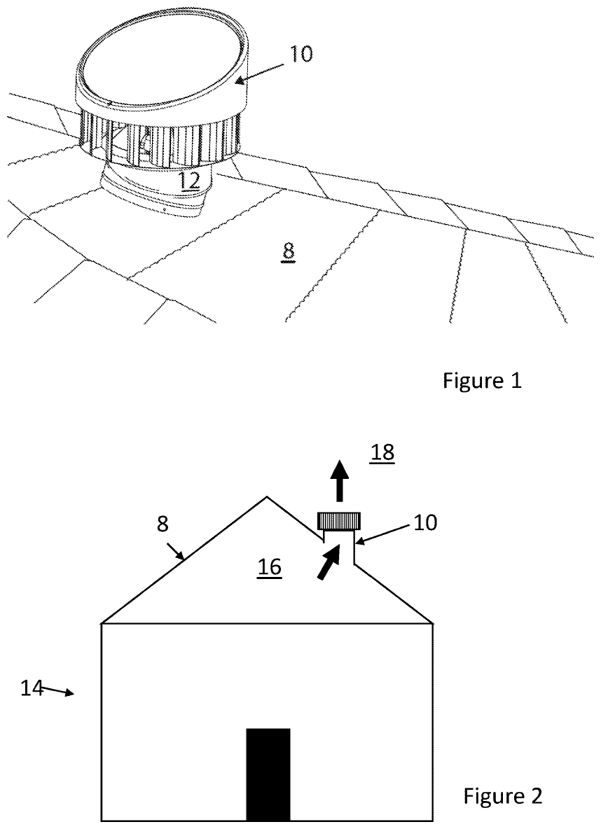

FIG. 1 is an embodiment of the roof ventilator 10 mounted on a roof 8. The throat 12 comprises an opening in the roof 8 as can be seen in the cross-section of FIG. 2. The roof ventilator 10 includes a passageway defined by a wall, at least part of which extends upwardly from the roof 8. Air travels from the roof space 16 of house 14 in the direction of the arrows. The throat 12 allows for fluid communication between the roof space 16 and the outside atmosphere 18.

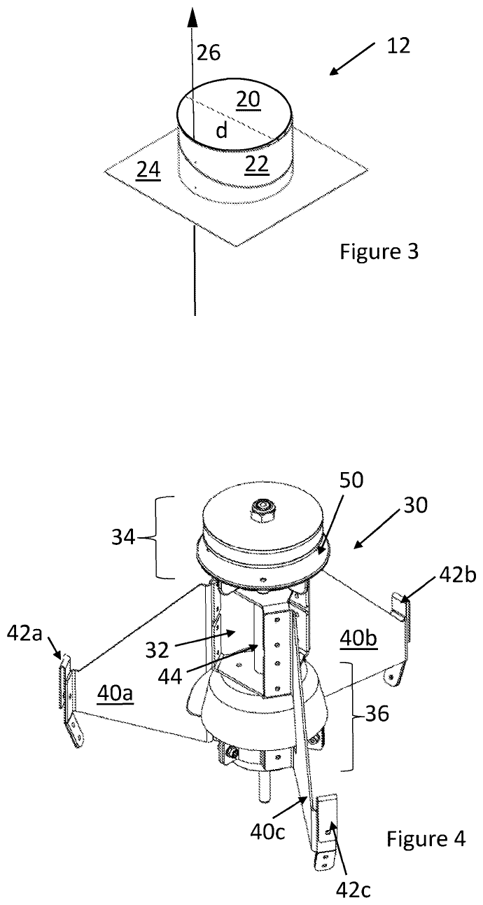

The throat has an inside surface 20 and an outside surface 22. In an embodiment, as seen in FIG. 3, the cross-sectional area of the passageway 26 of the throat 12 is circular. A circular passageway provides a low friction air tunnel through which air can be evacuated in the direction of the arrow shown. The throats passageway 26 can be about 30 cm in diameter (d). The throat 12 can be mounted on a flat support 24 which can lay flat against the roof 8 like flashing.

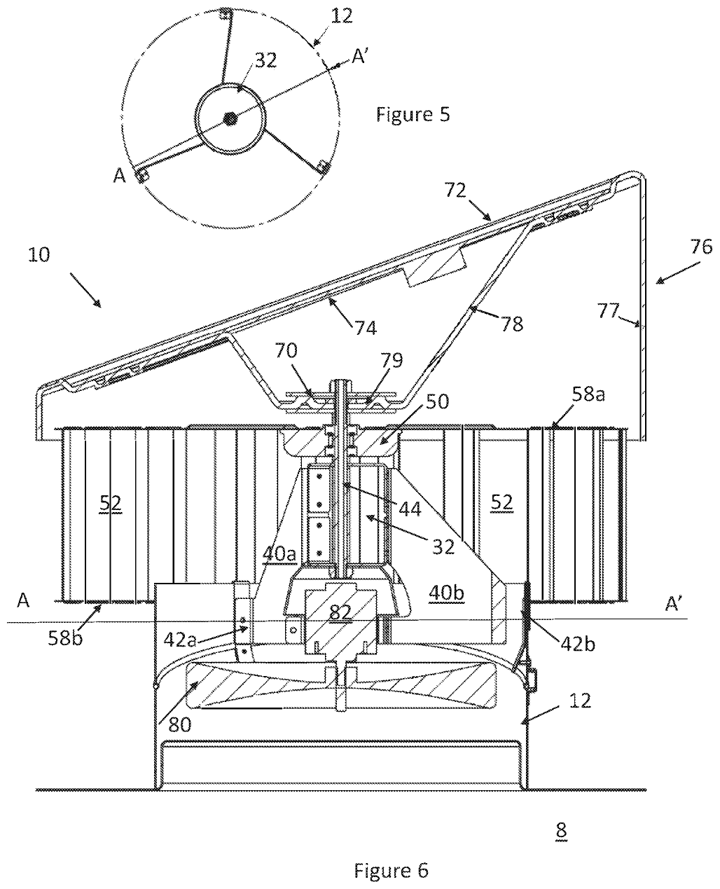

The roof ventilator 10 comprises a support assembly 30 for attaching the roof ventilator 10 to the inside of the throat 12. The attachment can be by engagement with the inside surface 20 of the throat 12. Since air needs to pass through the throat, preferably the support assembly is as streamlined as possible and allows passage of air therethrough. In an embodiment, the support assembly 30 comprises a body 32 having a top part 34 and a bottom part 36. The top part 34 of the body 32 is located in use towards the top of the throat 12. The bottom part 36 of the body 32 is located towards the bottom of the throat 12 closest to the roof space 16. As can be seen in FIG. 6, once in position, the body 32 can extend mostly out of the throat 12 so that the parts of the roof ventilator can function clear from the throat 12 walls and clear of the roof 8. As will be apparent also from FIG. 6, the body 32 can have a smaller diameter to that of the throat 12 to allow air flow around it. In an embodiment, the body 32 is substantially cylindrical and is about one-third of the diameter of the throat or smaller. The body 32 can form an annulus with the throat 12 defined by the outside surface of the body and the inside surface of the throat (see FIG. 5). Air can flow around the outside surface of the body 32 through the annulus.

A plurality of support arms 40 can extend from the body 32. In the Figures there is shown an embodiment with three support arms 40a, 40b, 40c. Each arm 40 is preferably as thin as possible when viewed in the wind direction (i.e. a birds eye view from the top of the throat down the passageway as seen in FIG. 5). It is thought that three arms 40a, 40b, 40c may be optimum for secure and stable, vibration free attachment of the body 32 to the throat 12 and for optimising air passage.

Each arm 40a, 40b, 40c can be a solid aerodynamic fin as seen for example in FIG. 4. The fin 40 can be substantially triangular in shape having a wide part extending from the body 32 and tapering to the location at which the arm 40 joins the throat 12. The fin 40 can be arranged so as to have its narrowest dimension (i.e. the thin cross sectional area) disposed in the direction of proposed air flow through the throat 12 (as shown in cross-section in FIG. 4). As can be seen in the embodiment of FIG. 4, to reduce any torsional forces applied to the body 32 by air flow over the fin 40, the radial fins are slightly offset from the body 32.

Each support arm 40a, 40b, 40c is affixed to the inside wall 20 of the throat 12 by a fixing means 42. In the embodiment shown, the fixing means comprises a plate 42 having an upper hook part for hooking over the rim of the throat 12. Once the plate is hooked over the rim of the throat 12 it can be fixed into position with a screw and nut. A further location of fixing can be by means of further screw holes provided on the plate at a location such that one or more screws can be applied through the throat fixing the plate in place. Each of fixing means 42a, 42b, 42c are applied to ensure that the body 32 of support assembly 30 is firmly held in place in throat 12. In the cross-section of FIG. 6 fixing means in the form of plate 42 can be seen in position hooked over the rim of throat 12 and screwed at the hook location and at its lower end.

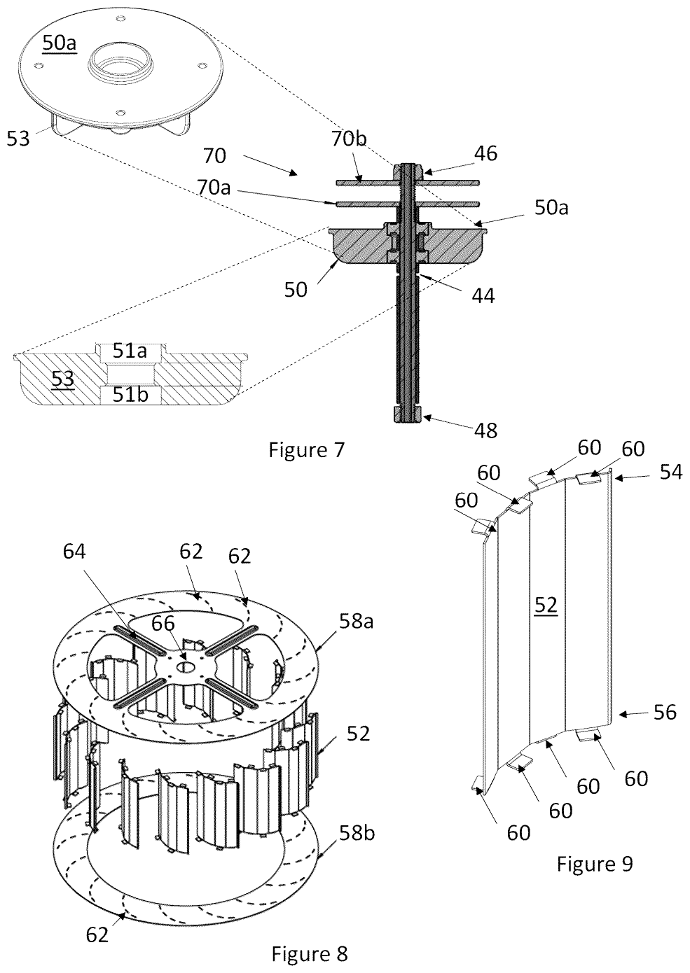

The body 32 of the support assembly 30 can be formed from a series of brackets to which the support arms 40 can be attached. can be solid. A passageway can run through the body in the form of a shaft 44. FIG. 7 shows the shaft in isolation from the body 32 for clarity. The shaft 44 is held in place relative to the body 32 by means of a fastening force nut (8 Nm) 46 at the top part 34 and a fastening force nut (8 Nm) 48 at the bottom part 36.

The body 32 of the support assembly 30 can comprise the blade support assembly 50. The blade support assembly 50 is rotatable relative to the body 32. In an embodiment, the blade support assembly 50 is rotatable around the shaft 44 provided as a part of the body 32. The blade support assembly 50 can spin around the shaft 44 when manual force is applied to it. However, the intended use is that the blade support assembly 50 will support a series of blades 52. The blades or vanes 52 are intended to be pushed under the influence of wind in the outside atmosphere 18.

In order to facilitate rotation, there can be a plurality of friction reducing bearings located close to the point of friction between the shaft 44 and the blade support assembly 50. In an embodiment, the blade support assembly comprises two sets of friction reducing bearings 51a and 51b spaced from one another. There can be a first series of friction 51a reducing bearings spaced by about 5 mm from a second series of friction reducing bearings 51b. The blade support assembly can also comprise reinforcing fins 53. In an embodiment there are four radial reinforcing fins 53.

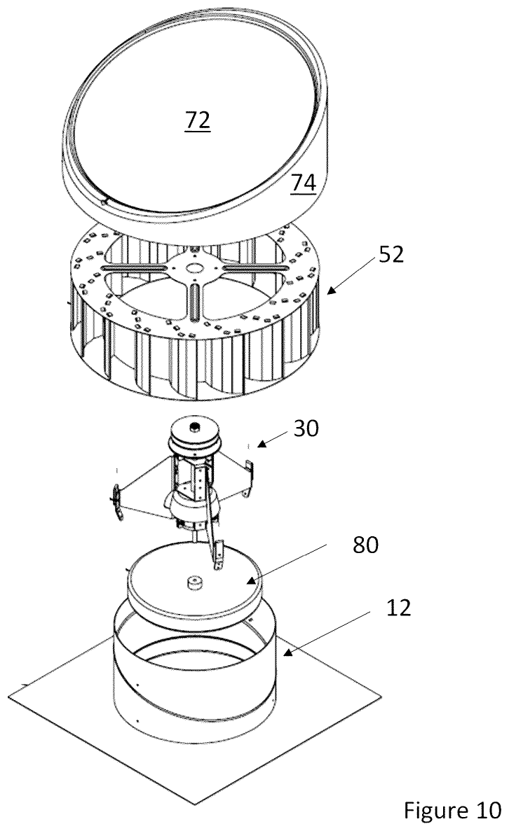

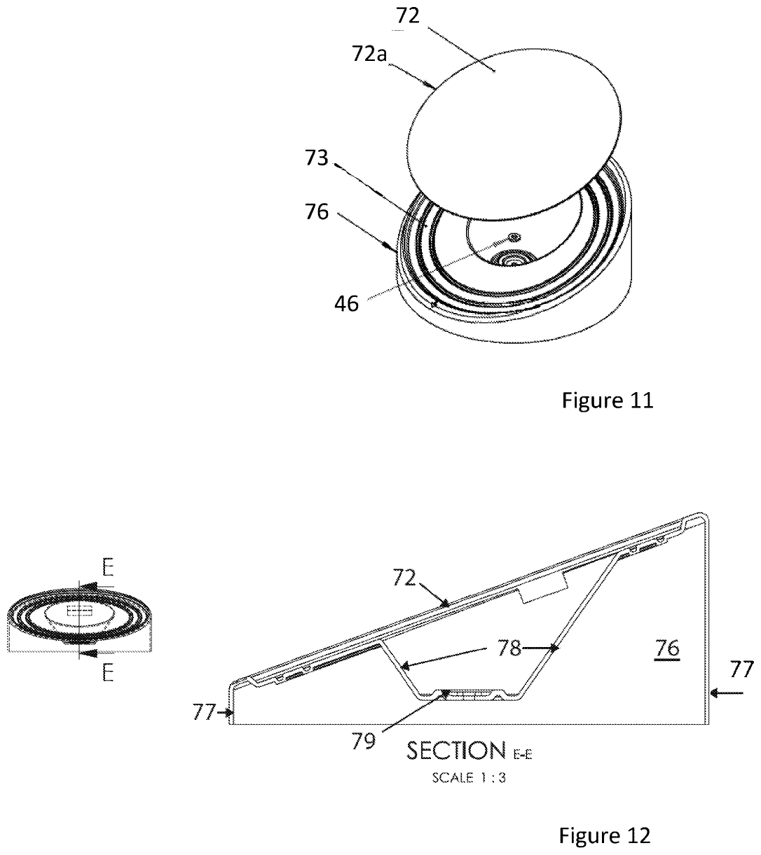

Each blade 52 is formed from a plurality of flat surfaces arranged to provide an overall curve like shape as can be seen in FIG. 9. The blades arranged together in a blade mount 58 is shown in exploded view in FIG. 8. The series of blades 52 are moved by the wind so they are oriented so that they can catch the wind and be moved by it. There can be about sixteen blades in the series of blades 52 disposed adjacent to one another, arranged vertically, in a ring shape. Each blade 52 can be offset from the next blade to optimise air capture. The blades 52 can be mounted at their upper ends 54 and lower ends 56 into a blade mount 58 that fixes them into position. The blade mount 58 can have an outside diameter greater than the diameter of the throat 12, so that the series of blades 52 sits outside the throat 12 as shown in e.g., FIG. 6.

The blade mount 58 can comprise a first wheel shaped portion 58a and second wheel-shaped portion 58b. The blades 52 can engage with each wheel-shaped portion 58a, 58b and can thereby form a structure that can be coupled with the blade support assembly 50. The engagement of each blade 52 with the blade mount 58 can be by tabs 60 arranged on each blade 52 which can pass through slits 62 on the surface of the blade mount 58. The first wheel shaped portion 58a can have spokes 64 meeting at a central hub having an aperture sized to fit over shaft 44. When the blade mount 58 is threaded onto shaft 44, the hub rests on the ledge 50a of the blade support assembly. The blade mount 58 can be fixed to the ledge 50a of the blade support assembly with e.g. screws.

When fixed to the blade mount 58, the blades 52 cannot move relative to the mount. If a blade 52 cannot move, when struck by the wind, the energy in the wind will cause a pushing force against the blade surface 52 that will try to move the blade 52. Since the blade 52 cannot itself move, the wind energy is transferred to the blade support assembly 50 which rotates about the friction reducing bearings. When moving in the wind, the blades 52 spin and whirl, hence the term whirlybird sometimes being attributed to such an arrangement.

At the top of the support assembly there is a solar panel support assembly 70 for supporting a solar panel 72. The solar panel 72 comprises a plurality of solar or photovoltaic (PV) cells, which can be used to generate electricity through photovoltaic effect. Each PV cell can convert solar radiation to electrical energy. The upper surface of the solar panel 72 should be facing sunlight. The lowermost or underside surface 74 of the solar panel 72 can comprise electronic circuitry that will convert and then pass electricity formed by the cell 72 (via wires) to another location for use. In an embodiment, the electricity formed could be saved into a battery.

The solar panel 72 can weigh about 5 to about 10 kg (or more) depending on its size, so the solar panel support assembly is preferably robust and stable once the panel is in position on the solar panel support assembly 70. The solar panel 72 is preferably held at or towards its peripheral edge 72a to ensure complete support and any reduced tendency for the panel to twist or flex which could cause damage to the PV cells. In an embodiment, the solar panel 72 is held into a solar mount 76. The solar mount 76 can comprise a frame 77 that supports the edges 72a of the panel 72, and an elevator 78 which elevates the frame 77 upwards relative to the solar panel support assembly 70 so that the solar panel 72 is arranged away from the series of blades 52 and can be otherwise free from obstruction and disposed in sunlight. The frame can comprise a surface 73 onto which the solar panel 72 can be placed. The surface can comprise concentric ribs to provide support to the underside of the solar panel 72. The concentric ribs 73 can assist with the waterproofing/adherence/mounting of the solar panel 72 to the upper platform 70a. The solar panel support assembly 70 can comprise a platform 70a, 70b on which the solar mount 76 can be coupled. The coupling can be by bolting the lowermost part of the elevator 78 to the platform 70a, 70b. In an embodiment, the platform 70a, 70b comprise an upper platform 70b and a lower platform 70a. There can be a solar mount foot 79 at the lowermost part of the elevator 78. The solar mount foot 79 is configured to be received between the upper platform 70b and the lower platform 70a and then sandwiched into position. To install the solar mount 76, the upper platform 70b can be removed from the shaft 44. The solar mount 76 can have an aperture therein that can receive the shaft 44. The fastening force nut (8 Nm) 46 can be attached to the shaft to hold the solar mount 76 into position. A force of approximately 8 Nm allows the upper platform 70b and lower platform 70a to be firmly held in place in normal conditions with no movement relative to throat. It allows, under “force/stress”, the solar panel support assembly 70 to be orientated, once fixed to the throat 12, to maximise the benefit of the sun. A rib can be formed into solar mount foot 79 to increase rigidity. The concentric rib moulding may, along with broad metal washers, and the characteristics of the top module's vacuum formed material properties, allow the sturdy fastening of the complete mechanism under a controlled fixing force (of about 8 Nm), whilst allowing the solar panel 72 to be independently orientated to the North direction.

At the bottom of the support assembly, there is a solar powered fan 80. The solar powered fan 80 has a rotating arrangement of four blades disposed horizontally in the lower part of the throat 12. The fan 80 can be about 10% less in diameter than the diameter of the throat 12, so as to allow the fan 80 to rotate without the blades striking the inside surface 20 of the throat 12.

The solar powered fan 80 can be powered by electricity generated by the solar panel 72. In order to receive electricity from the solar panel 72, the solar powered fan 80 needs to be electrically connected to the solar panel 72. In an embodiment, the electrical wires from the solar panel 72 can travel along the passageway formed in the shaft 44 of the body 32 of the support assembly 30 into the solar powered fan 80/

The solar powered fan 80 sits in the throat 12 and is turned by the energy delivered to it by the solar panel 72. Accordingly, the solar powered fan is not reliant on wind energy to drive it and thus can operate in high winds or in low winds. In an embodiment in which a battery is provided, there can be a blade spinning sensor which detects when the series of blades 52 is not spinning in the wind. When the blade spinning sensor communicates that the blades 52 are not spinning, a message can be sent to the solar powered fan motor 82 to activate and take over.

In an embodiment, the motor 82 driving the solar powered fan 80 can receive energy from the solar panel 72 directly and spins constantly notwithstanding whether the series of blades 52 is turning or not.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Any promises made in the present description should be understood to relate to some embodiments of the invention and are not intended to be promises made about the invention as a whole. Where there are promises that are deemed to apply to all embodiments of the invention, the applicant/patentee reserves the right to later delete them from the description and does not rely on these promises for the acceptance or subsequent grant of a patent in any country.

1. A roof ventilator for use with a throat mounted onto a roof so as, in use, to provide fluid communication between an interior of a roof space and an outside atmosphere, the roof ventilator comprising:
a support assembly for attaching the roof ventilator to the throat, the support assembly comprising:
a body having a top and a bottom;
a plurality of support arms extending from the body for engagement with an inside surface of the throat, and
a passageway running through the body from the top to the bottom;
a solar panel support assembly, for supporting a solar panel, located at the top of the support assembly;
a solar powered fan powered by a motor, each of which are located at the bottom of the support assembly;
a blade support assembly provided on the body rotatable relative to the body;
a series of blades mounted to the blade support assembly, the series of blades adapted to spin under influence of air movement from the outside atmosphere;
wherein, electronic circuitry from the solar panel travels from the solar panel through the passageway to the motor that powers the solar powered fan; and
wherein the roof ventilator is able to evacuate air either under the influence of movement of the series of blades and/or by operation of the solar powered fan.

2. The roof ventilator of claim 1, wherein the motor of the solar powered fan is fixed and does not rotate in use.

3. The roof ventilator of claim 1, wherein a cross-sectional area of the passageway of the throat is circular.

4. The roof ventilator of claim 1, wherein there are three support arms extending from the body for engagement with the inside surface of the throat.

5. The roof ventilator according to claim 1, wherein each support arm is an aerodynamic fin having a substantially triangular shape with a wide part extending from the body and tapering to a location at which each support arm engages with the inside surface of the throat.

6. The roof ventilator according to claim 5, wherein engagement of the support assembly to the throat is by a fixing mechanism located at the location at which each support arm engages with the inside surface of the throat.

7. The roof ventilator according to claim 1, wherein each blade is a flat piece of material having a first face and a second face, longitudinal sides and an upper and lower end, and the blades are each mounted at their upper and lower ends into a blade mount that fixes each blade into position.

8. The roof ventilator according to claim 1, wherein there are sixteen blades in the series of blades each arranged vertically adjacent to one another to form a ring shape.

9. The roof ventilator according to claim 1, wherein each blade is formed from a plurality of flat surfaces configured to provide an overall curve shape.

10. The roof ventilator according to claim 1, wherein the solar panel is substantially circular in shape and is inclined in a direction to optimise collection of sunlight.

11. The roof ventilator according to claim 1, wherein the solar panel is open to sunlight without any obstruction between photovoltaic cells of the solar panel and rays of the sunlight rays that strike the photovoltaic cells.

12. The roof ventilator according to claim 1, wherein the solar panel support assembly is rotatable relative to the throat to change an orientation of the solar panel.

13. The roof ventilator according to claim 1, wherein the support assembly includes a hollow shaft, and the passageway through the body is formed by a wall of the hollow shaft, wherein the electronic circuitry from the solar panel passes through the hollow shaft.

14. The roof ventilator according to claim 13, wherein the blade support assembly is rotatable around the hollow shaft, which remains fixed and not rotatable in use, and, in order to facilitate rotation, there are one or two or more sets of friction reducing bearings provided on the blade support assembly spaced from one another along the hollow shaft.

15. The roof ventilator according to claim 14, wherein a first series of the one or two or more sets of friction reducing bearings is spaced by about 5 mm from a second series of the one or two or more sets of friction reducing bearings.

16. The roof ventilator according to claim 13, wherein the solar panel support assembly comprises a solar mount having a frame that supports edges of the solar panel, and an elevator which elevates the frame upwards relative to the support assembly.

17. The roof ventilator according to claim 16, wherein the solar panel support assembly further comprises an upper platform and a lower platform arranged on the hollow shaft for coupling the solar mount to the support assembly via the elevator.

18. The roof ventilator according to claim 17, wherein there is a solar mount foot at a lowermost part of the elevator of the solar mount, and the solar mount foot can be received between the upper platform and the lower platform and then sandwiched into position.

19. The roof ventilator according to claim 18, wherein a concentric rib is formed into the solar mount foot to increase rigidity and to facilitate sturdy fastening under a controlled fixing force, whilst allowing the solar panel to be movable relative to the throat.

20. The roof ventilator according to claim 1, wherein power generated by the roof ventilator can be captured and stored in a battery.

21. The roof ventilator according to claim 1, wherein operation of the roof ventilator is monitorable and or controllable by an electronic device.

22. Installation of one or more roof ventilator(s) according to claim 1 onto a respective roof.
